(19) United States
(12) Patent Application Publication
(10) Pub. No.: US 2024/0299885 A1
(43) Pub. Date: Sep. 12, 2024

(54) Tangential Filtration Elements and Filtration Devices and Methods Of Use

(71) Applicant: Yingqing Huang, Buffalo Grove, IL (US)

(72) Inventor: Yingqing Huang, Buffalo Grove, IL (US)

(21) Appl. No.: 18/531,697

(22) Filed: Dec. 7, 2023

Related U.S. Application Data
(60) Provisional application No. 63/521,755, filed on Jun. 19, 2023.
(60) Provisional application No. 63/451,573, filed on Mar. 11, 2023.

(51) Int. Cl. B01D 69/04; B01D 63/04; B01D 63/06; B01D 69/08; B01D 69/12

(52) U.S. Cl. CPC B01D 69/046; B01D 63/04; B01D 63/069; B01D 69/081; B01D 69/12; B01D 2313/041; B01D 2313/18; B01D 2313/19; B01D 2313/205; B01D 2315/10; B01D 2319/022; B01D 2319/04

(57) ABSTRACT

In some embodiments thereof, the present invention describes TFF (Tangential Flow Filtration) filtration devices that utilize tubular membranes for the separation of cells and particles. These devices encompass several innovative features, including the use of membrane tubes with either circular or non-circular cross-sections. These tubes are closely surrounded by both tube housing and filter housing to regulate the pressure of the liquid exiting the filter housing. Additionally, the membrane tubes may feature internal cores within their lumens and/or structures along their inner walls. These internal features serve to regulate flow patterns and pressures within the tubes. One notable aspect of this invention is the inclusion of features on the tube housing or tube core that effectively regulate pressure resistance and feed flow patterns. These features lead to a reduction in the required recirculation rate and contribute to improved transmembrane pressure profiles, making these membrane filters highly effective for cell retention in cell culture and other applications. The patent also introduces various filter designs that incorporate tubular membranes into TFF filtration devices to achieve multiple goals, including a more consistent TMP (Transmembrane Pressure) profile for efficient separation, reduced recirculation rates to generate adequate shear rates, higher packing densities of membrane surface areas within the same filter design, and enhanced manufacturability and recyclability of the filters. Overall, this invention represents a significant advancement in the field of TFF filtration, offering innovative solutions for a wide range of applications in the separation of cells and particles.

### CROSS-REFERENCE TO RELATED APPLICATIONS

The present invention claims priority benefit from provisional patent application No. 63/521,755 filed on 19 Jun. 2023. This application also claims priority benefit from provisional patent application No. 63/451,573 filed on 11 Mar. 2023. The referenced applications are hereby incorporated in their entirety herein by reference.

### FIELD OF INVENTION

The present invention relates to innovative tubular membrane filter designs for tangential flow filtration that enable high surface area packing density, precise control of transmembrane pressure, reduced recirculation rates, and improved efficiency and scalability for large-scale separation and purification processes like cell perfusion and protein concentration.

### BACKGROUND OF THE INVENTION

Cultivated meats and alternative proteins have garnered attention for their potential to reduce greenhouse gas emissions, mitigate land and water resource demands, and improve animal welfare. They represent environmentally friendly alternatives to traditional meat sources, with the capacity to partially replace meat products while promoting sustainability. The production of cultivated meats entails inoculating animal cells with desired characteristics into carefully designed culture media within bioreactors, fostering cell proliferation. The culture media play a pivotal role by providing essential nutrients such as amino acids, glucose, growth factors, and albumins, which are vital for supporting cell growth and viability.

In the course of cell culture processes, living cells generate metabolic waste products, including lactic acid and ammonia, which must be efficiently controlled or eliminated to maintain high cell viability and enhance cell yield. The importance of perfusion technologies becomes evident, as they enable the separation of cells from depleted media and the introduction of fresh media into the bioreactor, boosting overall cell productivity.

Two key technologies used for cell separation in perfusion applications are Alternative Tangential Flow (ATF) and Tangential Flow Filtration (TFF). These approaches leverage semi-permeable membranes to separate cells from the culture medium. Various options are available for the configuration of these membranes, including flat sheet cassettes, hollow fiber modules, and tubular membranes. However, the use of hollow fiber (HF) or flat sheet cassettes is not without challenges, primarily due to their relatively low separation flux (typically 20 LMH or less). This limitation necessitates a larger membrane surface area and higher flow rates for recirculation in TFF operations.

Tubular membranes, with large lumens and fabricated from diverse materials such as polymers, metals, ceramics, or composite materials, prove to be efficient in TFF modes. Filters incorporating large pore tubular membranes (or hollow membrane tubes) with pore sizes of 2 μm or larger are also employed for cell separations. Notably, Repligen has developed TFDF membranes with a pore size rating of 2-5 μm for perfusion applications, offering high fluxes at 400 LMH or higher. However, these membranes require a high recirculation rate (2 L/min/tube or more), which restricts their suitability for large-scale perfusion applications.

Current TFF membrane separation technologies are inadequate for large-scale perfusion applications, as they struggle to provide the required high concentration ratios due to their low flux and necessitate extensive surface areas. These limitations present critical engineering challenges, particularly for bioreactors exceeding 2,000 liters in size, alongside elevated costs.

Extending the length of fibers is a potential solution to enhance the concentration ratio, but it poses difficulties in maintaining optimal transmembrane pressure due to substantial pressure differentials within the hollow fibers. In such scenarios, the pressure drop inside the tube exceeds what occurs outside the tube in the interstitial area, and only a portion of the surface area operates at an optimum transmembrane pressure. Therefore, filtration devices capable of delivering consistent transmembrane pressure are highly sought after.

Repligen's TFDF technologies leverage tubular membrane filters with pore sizes of 2-5 μm for cell retention in perfusion applications. These filters offer high flux in tangential flow filtration (TFF) mode to separate cell culture medium from cells. However, the trade-off is that they require a higher recirculation rate per tube to prevent excessive membrane fouling. Consequently, the existing TFDF hollow fibers are not ideal for large-scale applications exceeding a few thousand liters.

Both ATF, TFF, and TFDF perfusion technologies are engineered for single-use applications, primarily suitable for the biotech and pharmaceutical sectors. However, they prove to be cost-prohibitive and generate substantial plastic waste, making them less viable for the food industry. Therefore, there is a pressing need for filter designs that combine the high flux properties of macroporous membrane tubes with a high surface packing density, reduced recirculation rates, and reusability, ensuring both cost-effectiveness and environmental friendliness for large-scale applications.

In addition to cultivated meats, precision fermentation holds promise for environmentally friendly alternatives, encompassing proteins and other food ingredients. The viability of these alternative proteins depends on their ability to be produced at a large scale and in a cost-efficient manner. Precision fermentation, applied to the production of milk and egg proteins and other food ingredients, requires large-scale tangential flow filtrations for tasks such as concentration and purification. Current technologies, relying on membrane flat sheet cassettes and hollow fibers, fall short in terms of service life compared to ceramic membranes. Ceramic membranes are known for their exceptional service longevity, often lasting years without requiring replacement. However, conventional ceramic membrane formats, particularly in the form of membrane tubes, demand a substantial recirculation rate due to their relatively large tube inner diameter. This high recirculation rate translates to more extensive recirculation equipment, increased capital expenditure, and higher operating expenses. Ceramic membranes, with their long-lasting, multiple-usage capability and industrial-scale output, find applications in perfusion processes. However, for large-scale alternative protein production, the recirculation rate has the potential to become a bottleneck in downstream processing using ceramic filters.

The innovation described here introduces novel filter element designs and filter concepts based on tubular membrane filters, capable of delivering high surface area packing density, reduced recirculation rates, and improved separation performance through transmembrane pressure (TMP) regulation. These filter designs are versatile, compatible with a broad range of membrane pore sizes and chemistries, including ceramic, PVTF, PTFE, produced through sintered or melt-blown techniques. Furthermore, they can be adapted for various TFF applications beyond perfusion, including protein concentration, buffer exchange, general purification, and separations across diverse industries.

In some aspects, the flux requirement is a crucial consideration in the context of filtration technologies. Flux, representing the rate at which molecules or particles pass through a filtration membrane, directly impacts the efficiency of separation processes. Meeting or surpassing this flux requirement is often a challenging engineering task, as it necessitates larger membrane surface areas and higher flow rates for the recirculation of cell suspensions. Striking a balance between achieving higher flux and maintaining optimal transmembrane pressure (TMP) remains a critical engineering challenge in the pursuit of efficient and cost-effective filtration solutions, especially for large-scale applications. Addressing this challenge can significantly impact the viability and sustainability of various industries, including the cultivation of alternative proteins and cultivated meats.

As technology advances, fine mesh production offers additional opportunities for microfiltration applications, allowing for membrane pore sizes of one micron or larger. The innovative filter design introduced in this context has the potential to enhance the efficiency of mesh filters, contributing to a more sustainable and efficient filtration landscape across a multitude of applications.

### SUMMARY OF THE INVENTION

The following summary outlines the key innovations embodied in the system, method, devices, and apparatus described herein. It is important to note that this summary provides a concise overview of the invention's core features without intending to impose limitations beyond the scope defined by the detailed description and claims.

In some embodiments thereof, the present invention unveils a range of innovative filter element designs and filter configurations aimed at significantly enhancing filtration performance. These novel concepts introduce useful new features which may be applied individually or in combination to address various challenges in filtration processes.

### Filter Elements

One important disclosure contained herein is the introduction of a tube housing surrounding the membrane tube, which for purposes of this disclosure may be referred to as the tube housing design. The described design creates a thin gap between the inner surface of the housing and the outer surface of the tubing, as depicted in FIG. 1. In certain embodiments, the ends of this gap may be sealed, with small holes or orifices strategically placed along the tubing housing to allow permeate to exit. By varying the dimensions and distribution of these holes along the axial direction of the membrane tube, it becomes possible to create distinct flow resistance profiles along the tube. To further fine-tune filtration performance, the gap may be divided into one or multiple chambers, each with specific hole dimensions to regulate flow resistance. As the feed stream enters, chambers close to the inlet feature smaller holes or orifices, increasing the permeate flow resistance, while chambers closer to the outlet incorporate larger holes with reduced flow resistance. In some aspects, this arrangement ensures a consistent transmembrane pressure (TMP) profile along the membrane. Additionally, short sections of tubing and flow control devices may be interposed between chambers to provide further control over permeate pressure and TMP. These features are illustrated in FIG. 10.

Filter Element with Tube Housing and Gap as the Flow Channel

Another novel approach presented in this invention disclosure involves the use of a tube housing around each membrane tube to create a gap or narrow flow channel. The dimensions of this gap preferably increase in the direction of the feed flow. Permeate flows inside the gap as the designated permeate flow channel. By optimizing the gap's dimension and internal channel structure, it's possible to adjust the pressure drop for permeate flowing inside the gap to match the feed's pressure drop inside the membrane tube, thereby maintaining a consistent TMP along the membrane. The tube housing's internal structure may include baffles and flow channels to regulate pressure and turbulence in the permeate flow, as shown in FIG. 2. It's worth noting that patterned surfaces on the membrane tubes may also be employed to control flow, and the tube housing may feature textured or smooth surfaces.

### Filter Design Inside Out

In another aspect, this invention offers various approaches to integrate the membrane tube elements with housing into TFF (Tangential Flow Filtration) devices. In one implementation, one or more tubular membranes with external tube housing are secured within a TFF device, akin to a hollow fiber filter. This approach offers the benefit of a sealing potting design, and these filter elements may be further connected using flow distributors, employing house barb connections with sealing gaskets, while tubes with housing can potentially be removed and reused. This design is versatile and may be applied to TFF devices featuring one or multiple membrane tubes. FIG. 2b provides a visual representation of this approach. Detailed cross-sections and inner surface patterns for membrane tubes and tube housing are illustrated in FIGS. 2c and 2d.

In another aspect, the FIG. 5d provides an additional implementation of tube housing's surrounding membrane tube, wherein the feed flow are inside of the flow channel of membrane tube, and permeate are flowing between the tube housing and membrane tube. This design can reduce the hold up volume of permeate side in addition to capability of regulate permeate pressure. In some aspects. the membrane tube can be single channel or multiple channels.

### With Inserts

A fourth innovative strategy that is disclosed in this invention involves the inclusion of a core or insert within the lumen of a membrane tube to reduce the required recirculation flow rate. This core design, as shown in FIG. 3, facilitates the flow of the feed stream between the core and the inner lumen wall. The introduction of the core surface structure or the inner lumen surface structure can help control flow patterns and trajectories, ensuring proper shear rates and flow resistance to minimize membrane fouling. This approach contributes to the efficient reduction of recirculation rate while optimizing filtration performance. The design for a tubular membrane filter with a tube housing outside the membrane and an insert inside the membrane is presented in FIG. 3b. These inventive filter elements and configurations hold significant promise for enhancing filtration efficiency and performance across various applications.

### Non-Circular Membrane Tube Design

Further, and in a fifth aspect, this invention unveils filter designs that incorporate non-circular membrane tubes to augment surface area and reduce the required recirculation rate. In certain embodiments, the inner surface features flow guides or baffles to influence liquid flow patterns. In other instances, a core is introduced into non-circular membrane tubes to exert control over flow rate, flow trajectory, shear forces, and turbulence, akin to the design seen in FIG. 3 for circular-structured membranes. To maintain a consistent transmembrane pressure (TMP) profile, a tube housing encompassing these non-circular membrane tubes is utilized, applying the same tube housing features previously disclosed for circular membrane tubes.

These non-circular membrane tubes may be integrated into filtration devices in a manner akin to circular membrane tubes, as demonstrated in FIG. 4a. Within the filter tubing, internal structures may be employed to mediate flow patterns and feed flow resistance, as illustrated in FIG. 4a. On the exterior of the filter tube, structures may also be implemented to reduce the permeate hold up volume, control permeate flow patterns and flow resistance, as depicted in FIG. 4b. Membrane tubes may be amenable to a variety of shapes and may be arranged compactly to increase surface area packing density within a filter, as exemplified in FIG. 4c, showcasing diverse membrane tube shapes. The space between membrane tubes and the area between the tube and housing may accommodate structures or inserts to fine-tune the flow resistance of permeate, as seen in FIG. 4b. In yet another aspect, tube inserts may be added to the membrane tubes to regulate feed flow and turbulence levels.

### Outside In

A sixth aspect disclosed by this invention is that as the surface area of the outer wall exceeds that of the inner wall in a membrane tube, this invention introduces innovative filter designs that employ the external surface as the active filtration surface. This approach allows filtrate to flow from the outside to the lumen of the tubular membrane, utilizing a larger surface area for filtration operations. In one embodiment, a single membrane tube is incorporated with a filter housing, creating a slender gap between the membrane tube and the inner surface of the housing, as shown in FIG. 5a. In this configuration, one end of the membrane tube may be sealed, while the other end permits permeate to exit the gap for subsequent collection. The invention also presents designs that integrate multiple membrane tubes into a single Tangential Flow Filtration (TFF) device. One such design is illustrated in FIG. 5b, where several membrane tubes may be linked through a distributor at both filter inlet and outlet. In this design, all ports for feed inlet, outlet, and permeate may be housed within the filter's end cap. In some instances, the permeate ports may be located on the side of the filter housing. Depending on the embodiment, one end of the membrane tube may be sealed, left open, or sealed only at the inlet end, as portrayed in FIG. 5c and FIG. 5d. In certain scenarios, the tube housing may be utilized, directing the feed flow within the narrow gap formed between the tube housing and the membrane tube. In these embodiments with tube housing designs, the hold up volume can be significantly reduced. It is also noted, some of the these filter design can be used in using inner surface as working filtration surface as well.

### Outside in No Surround Housing for Closely Packed Membrane

According to a seventh aspect that is disclosed herein, in certain configurations, such as the one depicted in FIG. 6, where membrane tubes are densely packed together, structures, including spiral baffles, baffles of various shapes, grooves, and other features, may be incorporated into the feed's flow channel outside of the tube. These structures may be designed to control flow patterns, flow trajectories, and flow resistance (or differential pressure) for the feed flow. The distribution of these patterns may vary along the membrane tube to manage flow resistance and turbulence. These features or patterns may be situated on the inner surface of the membrane housing or on the outer surface of the membrane tube. Within the lumen of a membrane tube, a core may be inserted in some embodiments to regulate permeate flow patterns and maintain a suitable permeate pressure profile along the membrane tube. Varying dimensions and internal structures within the lumen may be employed to regulate flow resistance. In certain embodiments, a porous material rod may be inserted into the tubular membrane, featuring a duct in the center for permeate to exit, as shown in FIG. 7. The rod may also serve as a secondary filtration medium. Alternatively, a combination of these features can be implemented for advanced control. Threads can be created to secure the rod into the membrane tube.

### Wrapping Layers for Flow Resistance Control Inside Out

Furthermore, there may be alternative approaches to modulate permeate pressures for a tubular membrane filter. This invention may not explore all available options exhaustively. One approach involves encasing the membrane tube with fine fibers, membrane, or other materials to introduce additional layers of porous materials, thereby increasing flow resistance for each tube. The thickness and materials of these wrapped layers may vary from the feed inlet to the feed outlet. These layers may comprise a composite of the same or different materials and might not be semipermeable in certain sections of the membrane tube. It's also feasible to partially wrap the membrane tube. This layer can also be used to perform secondary filtration.

For ceramic Tangential Flow Filtration (TFF) filters featuring multiple tubes within a single cylinder, the wrapping materials may be applied externally to the cylinder, as demonstrated in FIG. 8.

### Wrapping Layers for Outsize in Out Flow Resistance Control

This invention additionally presents a surface structure design aimed at enhancing the external surface area for filtration, as depicted in FIG. 9. There are many other variations of outside structure to increase the membrane surface area.

### Stacking Module Design

In another aspect, the present invention introduces a filter element module design, portrayed in the FIG. 10a, along with relevant filter designs illustrated in FIGS. 10b to 10d. In this arrangement, tubular filters are segregated into multiple chambers on the permeate side, with each chamber possessing its dedicated permeate ports. These chambers exhibit varying permeate pressures along the axial direction of the membrane tube. To regulate transmembrane pressure (TMP) for each chamber, this invention also puts forth the concept of flow channels for permeate to traverse from one chamber to another. These flow channels may feature distinct dimensions to yield the necessary flow resistance for TMP control.

It's important to note that the membrane tube may assume various shapes, with oval, star-shaped, polygonal, or other configurations being viable options. The membrane tube may also incorporate two or more different materials, or it may be constructed using knitted mesh in lieu of a membrane and sintered tube. The membrane tube can have single channel or multiple channels.

The housing for each chambers can be in a complete pieces or can be connected with different pieces.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1a, b, c and d illustrate a tube housing for the control of permeate pressure, wherein: 1(a) is a chamber and orifice design; 1(b) shows a varying gap dimension design and structures inside the flow channel; 1(c) shows a tubular membrane filtration element with a tube housing regulating permeate flow, and 1(d) shows a tubular membrane with a tube housing regulating permeate flow and with a core with spiral thread in the middle to regulate permeate flow.

FIG. 2. is an illustration of TFF devices using tubular membrane with outside housing for improved TMP control and reduced hold up volume, wherein: 2(a) is a tubular membrane with a housing in hollow fiber filter design; 2(b) shows a tubular membrane connected using tube flow distributors; 2(c) is a cross section view of membrane tube with housing, and 2(d) illustrates a structure pattern on the inner surface of tube housing.

FIG. 3 (a) illustrates a core for inserting into tubular membrane lumen for the regulation of the feed flow, while 3(b) shows a filter with filter element with a core in a filtration membrane tube.

FIG. 4 is an illustration of TFF devices using non-circular membrane tube with feed flowing inside lumen, wherein: 4(a) is a cross section of non-circular membrane tubes inside a TFF device with tube inserts inside membrane tubes; 4(b) is a cross section of non-circular membrane tubes inside a TFF device, where there are structures inside the filter housing to mediate point permeate pressure, and 4(c) illustrates close packing of non-circular tubes and their arrangement in a filter.

FIG. 5 illustration membrane tube TFF devices with filtrate penetrate from outside the membrane tube into a lumen and with mechanisms for TMP control and feed shear rate enhancement, wherein: 5(a) shows feed flows in the thin space between the housing and the membrane tube with permeate being collected inside the lumen with one end of membrane tube closed; 5(b) shows a device with multiple tubes, wherein each tube has tube a housing and a tuber insert, where the permeate are connected through a flow distribution device, and both feed and permeate connection ports are on the filter end caps; 5(c) shows a multiple tube design, wherein the tube has a tube housing and an internal core, and the permeate are connected through a flow distribution device, with one end of the tube is closed; 5(d) shows a multiple tube design, wherein the tube has tube housing, with permeate ports are at the end caps, feed ports at the side of the filter housing, and; 5(e) shows a filter design using external surface as filtration working surface area and with tube with permeate ports at the side and tube housing with permeate ports at the side of the filter.

FIG. 6 is a TFF device using flattened membrane tube with filtrate flowing from outside to inside of membrane tube, wherein: 6(a) is a cross section view of non-circular membrane tubes inside a TFF device with feed outside the lumen and wherein structures inside filter housing restrict permeate flow; 6(b) is a feed flow from outside to the inside of lumen, with no tubing housing implemented but having a structure inside the housing but exterior of tube to mediate feed flow rate and flow pattern, and optional core inside filter lumen to regulate point TMP.

FIG. 7 illustrates a porous insert that can be secured into a membrane tube to mediate permeate pressure and potentially act as a secondary filtration medium.

FIG. 8 shows additional wrapping layers of materials surrounding a membrane tube to control point permeate pressures and potentially act as a secondary filtration medium.

FIG. 9 illustrates a pattern on the outer surface of membrane tube wall to increase membrane surface area and to regulate feed flow.

FIG. 10 (a) illustrates a modular filter element made of membrane tube with tube housing and a tube insert, which can be put in a filtration device, where the tube can be single channel or with multiple channels; 10(b) shows filters with sequentially connected filter elements, and independent permeate ports for each chamber; 10(c) shows sequentially connected modules and with internal flow channels connecting adjacent permeate chambers; 10(d) shows sequentially connected modules and with sequentially connected permeate chambers for permeate control.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not limit the technical spirit and scope of this invention. Accordingly, it should be understood that various changes and modifications may be made to the invention without departing from the spirit and scope thereof.

In some aspects thereof, this invention presents novel filter designs that could potentially enable a more uniform Transmembrane Pressure (TMP) throughout the axial direction of a membrane tube, resulting in reduced recirculation rate, improved concentration ratios, reduced hold up volume, and a potentially larger filtration surface area suitable for large-scale perfusion applications.

In state of the art applications, TMP measurements in Tangential Flow Filtration (TFF) devices are typically based on the average value for the liquid flowing from the filter inlet to the filter outlet. However, the actual TMP at specific locations within a membrane tube, referred to as point TMP, exhibits significant variations along the flow direction within TFF devices. This actual TMP can vary greatly from the filter inlet to the filter outlet, often with higher point TMP at the feed inlet compared to the outlet. Real-world applications may even result in near-zero or negative TMP values at the filter outlet, particularly when permeate pressure is high. Such non-uniform TMP profiles fail to ensure optimal operating conditions for all membrane surfaces. In extreme cases, negative TMP at the filter outlet can lead to permeate flowing back from the permeate side to the retentate side, counteracting filtration and leading to a situation referred to as ‘Starling flow.’

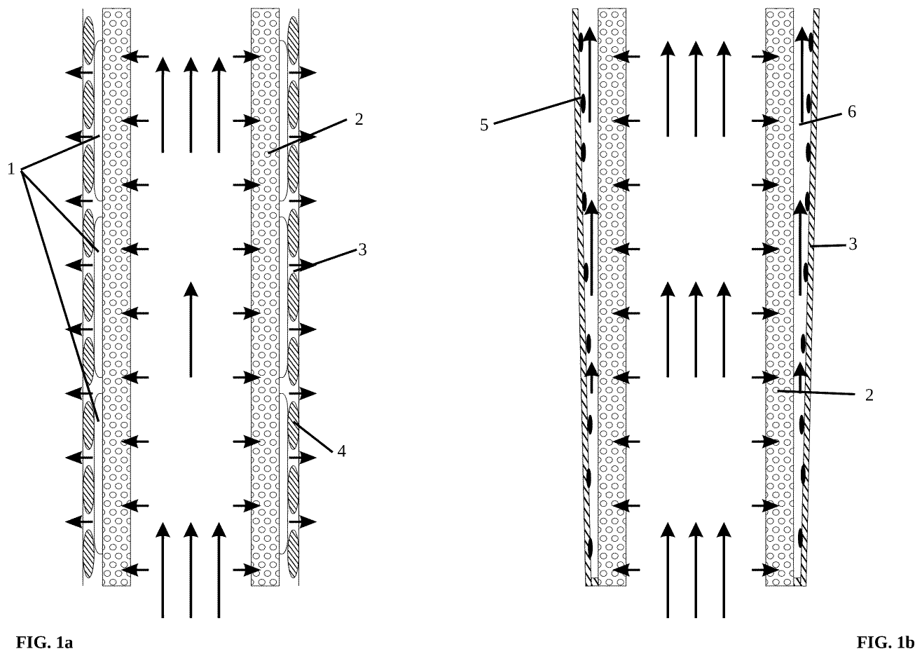

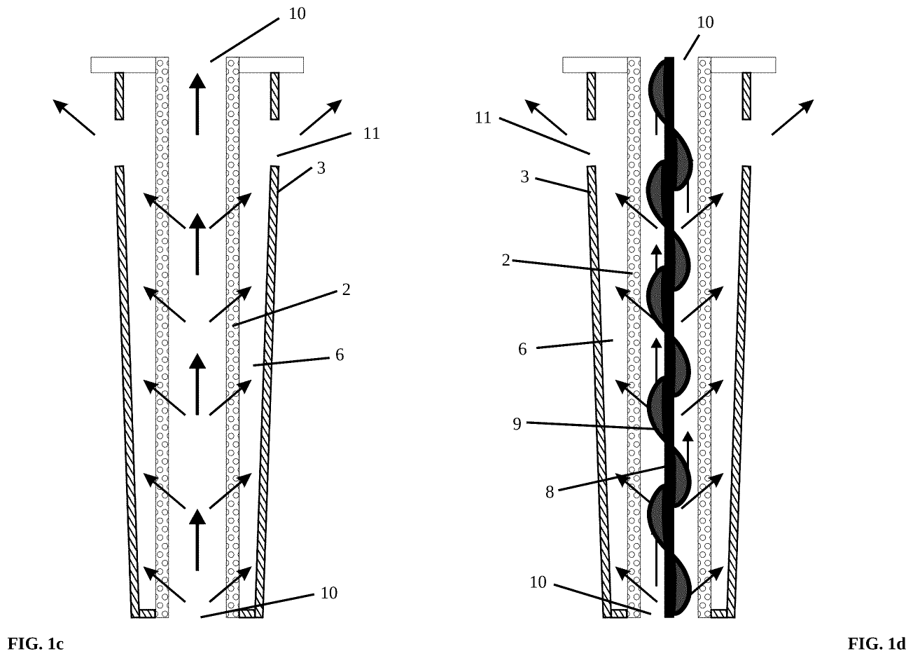

This invention discloses methods and techniques for achieving a more uniform TMP profile by controlling permeate pressure. In particular, the embodiments illustrated in FIG. 1 (a), (b), (c), and (d) depict the use of a tube housing for permeate pressure control. In (a), a chamber and orifice design is showcased, while in (b) it features varying gap dimensions and structures inside the flow channel. FIG. 1 (c), on the other hand, displays a tubular membrane filtration element with a tube housing 3 regulating permeate flow, while (d) demonstrates a tubular membrane with a tube housing 3 that regulates permeate flow and incorporates a core 8 in the middle to control permeate flow 11.

One approach presented in this embodiment involves the implementation of a tube (designated as 3) as a housing surrounding a membrane tube 2, referred to as the tube housing. This configuration creates a narrow or small flow channel 6 between the inner surface of the tube housing 3 and the outer surface of the membrane tube 2, as depicted in FIGS. 1a and 1b. In one design, the gap at both ends (that is at the top and bottom of the tubes) may be sealed, and small holes or orifices 4 may be incorporated along the tubing housing, allowing permeate to flow out of the chamber, as shown in FIG. 1a.

It is anticipated that one or more chambers may be configured. By adjusting the dimensions, shapes, numbers, and locations of these holes 4, the actual point permeate pressure decreases along the membrane tube 2 from the feed inlet 10. For example, closer to the inlet, fewer or smaller holes with higher flow resistance may be implemented to correspond to the higher inlet pressure, thereby reducing the point TMP at locations closer to the inlet with elevated pressure. Conversely, more holes and/or larger holes with reduced flow resistance may be implemented towards the outlet of the membrane tube, corresponding to lower outlet pressure. This approach ensures a more consistent TMP throughout the membrane tube.

In certain embodiments, the gap can be subdivided into multiple chambers from the tube inlet to tube outlet, as depicted in FIG. 1a. Each chamber may possess its specific pattern of pressure permeate holes on the tube housing. Segmenting the gap into multiple chambers provides an additional means to finely adjust the permeate pressure, particularly beneficial for longer membrane tubes. In other embodiments, a segment of fine tubing can be connected to holes/orifice 4 for permeate collection and TMP control. Moreover, a flow control device, such as a valve or flow restricting devices, may be attached to the tubing, where the flow resistance of permeate through the fine tubing can enhance permeate pressure and regulate TMP.

In further embodiments, the gap within the flow channel 6 between the tubular membrane 2 and tube housing 3 widens along the feed flow direction. Near the membrane tubing inlet, the gap may be narrower, inducing higher flow resistance on the permeate side, corresponding to the elevated feed pressure within the membrane tube. As one approaches the outlet of the membrane, the gap broadens, diminishing flow restriction in line with lower pressure and increased permeate flow rate towards the outlet, as presented in FIG. 1b. The gap may also integrate fluid guides and other structures 5 for modulating flow resistance, flow pattern, and permeate travel trajectory.

The membrane tube filtration element with tube housing 3 can be seamlessly integrated into numerous existing filter designs. For example, it can coexist with other membrane tubes, enabling sample flow through the lumen and permeate flow outside of the membrane tube but within the membrane housing, as illustrated in FIGS. 1c and 1d. Within the membrane tube, a tube insert or core 8 may be employed to fine-tune feed flow, as shown in FIG. 1d. The insert or core 8 may incorporate a structure 9 for regulating permeate flow 11.

It's essential to acknowledge that this invention cannot encompass all variations in permeate control designs for tubular membrane element design. Additional methods for regulating TMP may include varying structural features on the inner surface of the tube housing to ensure that point permeate pressure in the gap varies consistently with the pressure inside the membrane tube for feed flow.

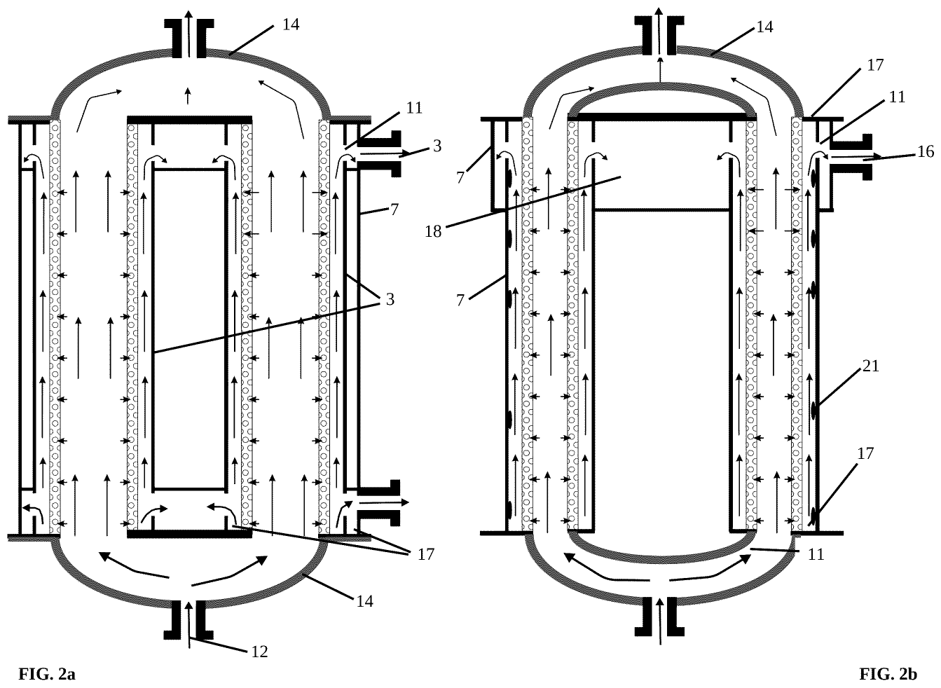

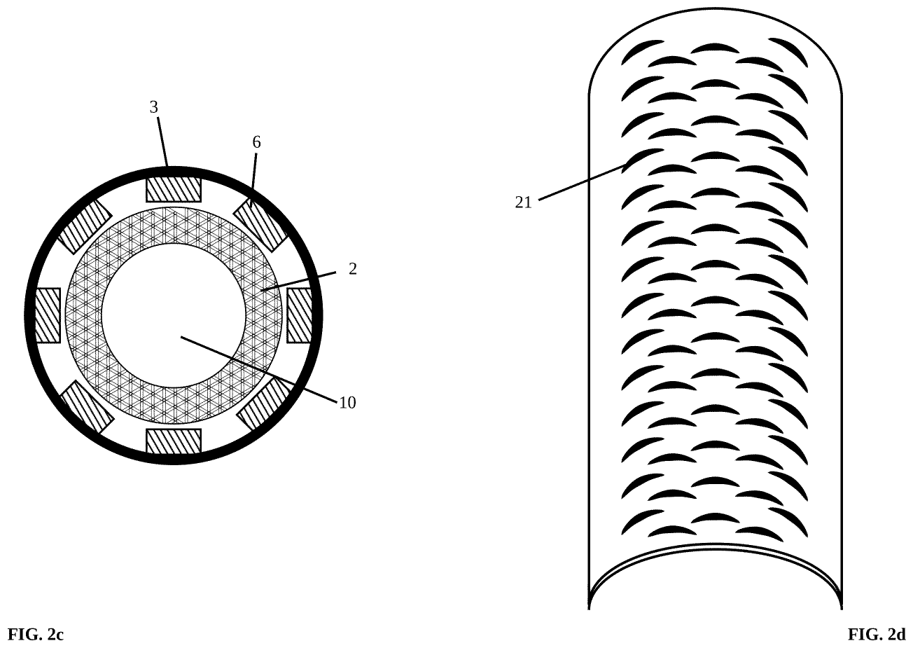

The tubular filter element depicted in FIGS. 1a and 1b can be integrated into a filter design, as demonstrated in FIGS. 2a and 2b. In FIGS. 2a and 2b, the membrane tubes can be composed of various materials, including ceramics, sintered polymers, or mesh filters made from polymers, metals, or metal alloys, or composite of these materials.

In one implementation, one or more of these membrane tubes may feature an exterior housing 7 and can be securely incorporated into a TFF (Tangential Flow Filtration) device, similar to potting hollow fibers in a filter. In certain embodiments, the membrane tubes 2, equipped with tube housing 3, are sealed within a filter housing 7 containing an end cap 14, as depicted in FIG. 2a. The sealing material 17 may comprise epoxy, polyurethane, or other suitable materials, or through mechanic sealing with gasket. The permeate flow initially traverses the membrane tube wall 2, entering the space between the tube housing and the membrane tube, and subsequently exits through the tube housing 3. It then proceeds into the filter housing and ultimately flows out through a filter, as shown by 11 in FIG. 2a.

This invention also introduces an alternative implementation, where the inlet or outlet of the tubular membrane tubes is directly connected to a flow distributor 20, as portrayed in FIG. 2b. One method of sealing, designated as 17 in FIG. 2b, involves utilizing hose barb connections to link these membrane tubes to the flow distributor. Other methods for connecting membrane tubes to the flow distributor, though not explicitly depicted, are considered to be within the scope of this invention. In addition, as depicted in FIG. 2b, a permeate chamber 18 is created within the housing while securing the membrane in a TFF device, enabling the permeate flow 11 from the respective membrane tubes to converge and exit the filter structure through the permeate port 16. This design can effectively reduce the permeate hold up volume. The tubular filter element depicted in FIGS. 1a and 1b can have two permeate port as shown in FIG. 2a, or 1 permeate port as shown in FIG. 2b.

It should be noted that, in these embodiments, the membrane tubes can encompass a broad spectrum of types, pore size ratings, and materials of construction, including metal mesh filters, with or without supportive layers.

Furthermore, various mechanisms can be employed to adjust the permeate flow resistance inside the tube housing. For instance, this invention introduces the use of baffles or flow guides 21 within the flow channel 6 to increase flow resistance within the tube housing 3. The shapes and distribution of these baffles and other types of flow guides may vary along the tube as illustrated in the cross-section of the tubular membrane filter element and a pattern on the inner surface of the tube housing are shown in FIG. 2c. It's important to note that, without limitation, at least one baffle or structure 21 can be incorporated on the inner surface of the tube housing, as demonstrated in FIG. 2d.

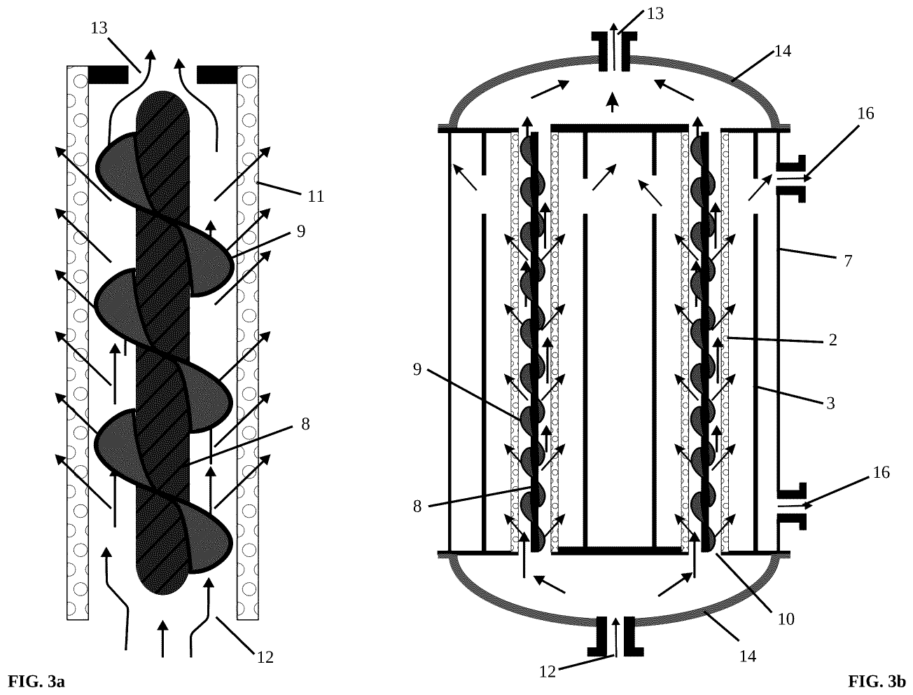

In order to reduce the required recirculation flow rate of the feed passing through each tube, a core 8 can be introduced into the lumen of a membrane tube 2. This core, also referred to as an insert, is securely positioned inside the membrane tube to decrease the cross-sectional area of the feed flow channel. By doing so, it mitigates the demand for a higher recirculation flow rate, ensuring that an optimal shear rate range is achieved, as demonstrated in FIG. 3a. In certain scenarios, the core can be fixed within the lumen of the membrane tube using various attachment methods, including screwing, gluing, friction, or any other suitable techniques, effectively reducing the flow channel dimensions between the inner surface of the tube and the outer surface of the core. FIG. 3b further provides an illustration of a filter element with a core situated inside the membrane tube. Within this innovation, the feed stream traverses within a flow channel of reduced cross-section, rather than the entire lumen serving as the flow channel 10. Consequently, a reduced recirculation rate is required to generate an adequate shear rate for mitigating gel formation during filtration.

It is noteworthy that the core depicted in FIG. 3 is not restricted to a cylindrical structure, as illustrated. The invention encompasses cores featuring various surface patterns or structures capable of regulating permeate flow and enhancing mixing. The flow channel or the core can incorporate baffles, spiral flow guides 9, or other features that influence flow patterns and turbulence levels. This core can be adapted for use in various types of tubular filters, including mesh filter tubes, with the dual benefits of reducing recirculation rates and regulating turbulence. Furthermore, the core can assume shapes other than cylindrical to accommodate membrane tubes of varying shapes, lengths, and axial orientations along the membrane tube.

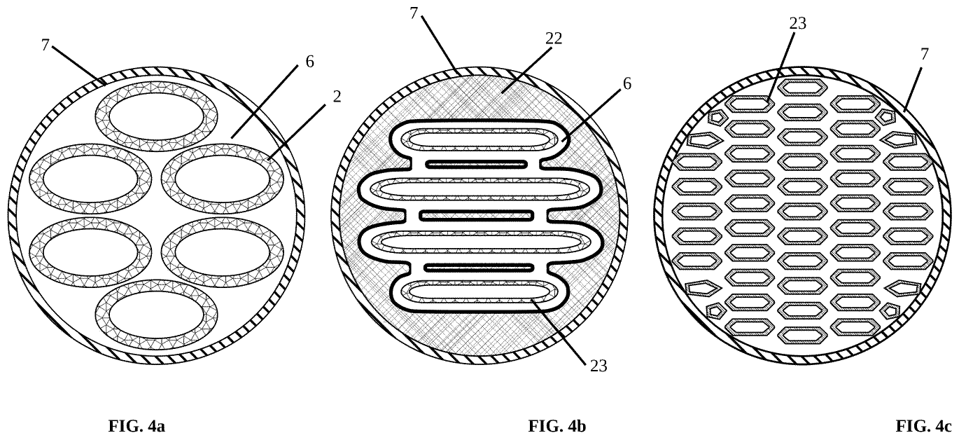

In some aspects, the present invention introduces innovative filter designs aimed at enhancing the performance of membrane tubes in tangential flow filtration (TFF) systems. Traditional circular membrane tubes, while efficient, present certain limitations due to their circular cross-section, resulting in less surface area relative to their cross section surface area. To address this constraint, this invention presents non-circular membrane tubes, such as flattened or uniquely shaped geometries (depicted as 23), to substantially increase the effective working area. The non-circular membrane tubes featured in FIGS. 4a and 4b demonstrate how they augment the surface area while concurrently reducing the feed flow rate requirement. The close arrangement of these non-circular membrane tubes further amplifies the effective working separation area. Consequently, filters of similar dimensions incorporating non-circular membrane tubes may potentially accommodate significantly larger surface areas compared to their circular counterparts. It is important to note that the scope of the invention extends to membrane tubes with various non-circular shapes, each contributing to an augmented filtration working surface area.

The innovative concepts introduced herein are not exclusive to non-circular membrane tubes. They are equally applicable to circular membrane tubes. Non-circular membrane tubes, for instance, can incorporate internal features such as flow guides or cores with suitable dimensions to regulate flow patterns, control recirculation flow rates, and enhance the efficiency of TFF processes.

The core itself can be constructed from various materials, including elastic or composite materials, designed to compress under higher pressure, thereby widening the flow channel for viscous samples. In one embodiment, the core may include flexible polymer baffles that deform to allow a more expansive flow channel, particularly accommodating high-viscosity samples or high flow rates. This unique core design mitigates membrane tube clogging and facilitates the processing of high-viscosity samples.

Furthermore, the invention encompasses the implementation of filter housing (depicted as 7) surrounding non-circular membrane tubes, with the primary objectives of regulating permeate flow patterns and mediating transmembrane pressure (TMP). In this configuration, permeate flows within the gap (22) formed between the tube housing and the membrane tube. The filter housing may incorporate structures (depicted as 22) that influence the flow pattern, turbulence levels, and flow resistance of the permeate flow in permeate chamber 6. These features ensure a more consistent TMP profile for non-circular membrane tubes. FIG. 4a offers a cross-sectional view of filters featuring non-circular membrane tubing with housing.

Notably, this invention provides flexibility by accommodating both tube housing and non-tube housing designs. Additionally, it introduces alternative devices that can be inserted between membrane tubes or between membrane tubes and filter housings to regulate flow resistance, control flow patterns, and enhance turbulence levels. One such embodiment, as demonstrated in FIG. 4b, involves the incorporation of flow restriction devices or inserts (depicted as 22) between the membrane tubes. These inserts may take the form of mesh structures, plates with surface features, solid pieces, or various shapes like baffles or flow guides, all designed to fit closely surrounding the membrane tube geometry. These versatile designs empower the efficient performance of TFF systems across a wide range of applications.

Further, this invention encompasses various filter designs, including configurations where not all membrane tubes feature housing. In these designs, as depicted in FIG. 4c, membrane tubes are positioned adjacent to each other, with the shapes of the membrane tubes allowing for minimal spacing between their walls. This close packing of membrane tubes significantly boosts the surface area packing density within the filter. Permeate traverses the reduced interstitial regions between these non-circular membrane tubes. In certain embodiments, screens or other structured components may be inserted between the membrane tubes to secure the membrane and fine-tune flow resistance and flow patterns of the permeate.

Additionally, this invention acknowledges that the internal surface of the membrane tube can incorporate structural features that augment the contact surface area for feed flow, consequently expanding the filtration surface area while influencing flow resistance and turbulence levels. These features can manifest as protruding ridges enhancing surface areas and promoting optimized filtration performance.

### Filter Design Using External Surface as Working Surface for Separation.

For membrane tubes with thick walls, the surface area of inner lumen surface is smaller than that of outer surface. As such, using the outer side surface for filtration can achieve higher the effective working surface area. However, this method is rarely seen in traditional TFF device design with tubular membrane, as it is difficult to achieve sufficient shear rate required to reduce the membrane fouling unless very high recirculation rate is used for TFF applications.

This invention disclosed innovative TFF devices that use external surface for filtration, wherein TMP can be optimized and/or flow rate for feed recirculation flow can be reduced.

### Single Tube Design Outside in.

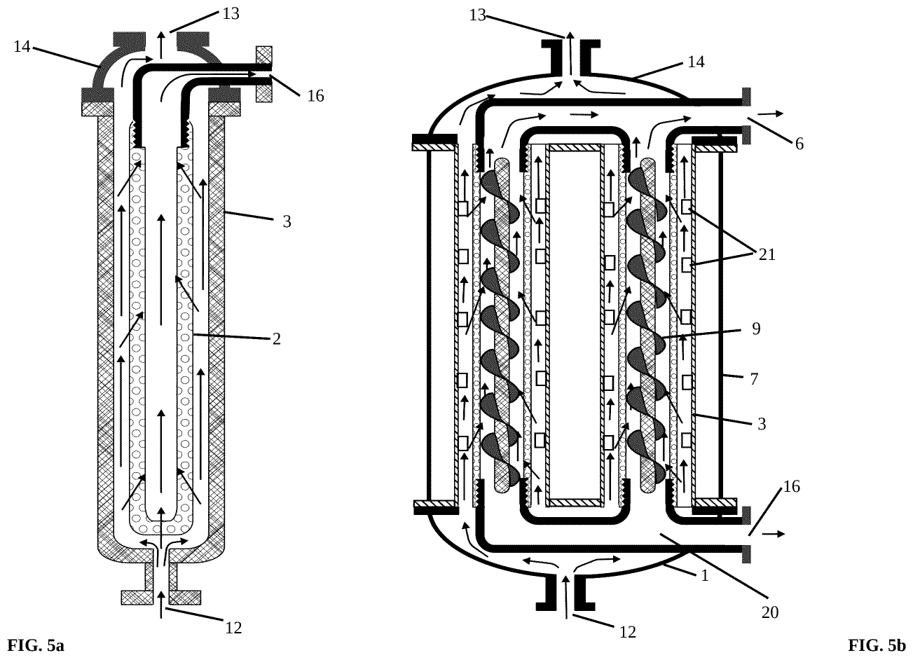

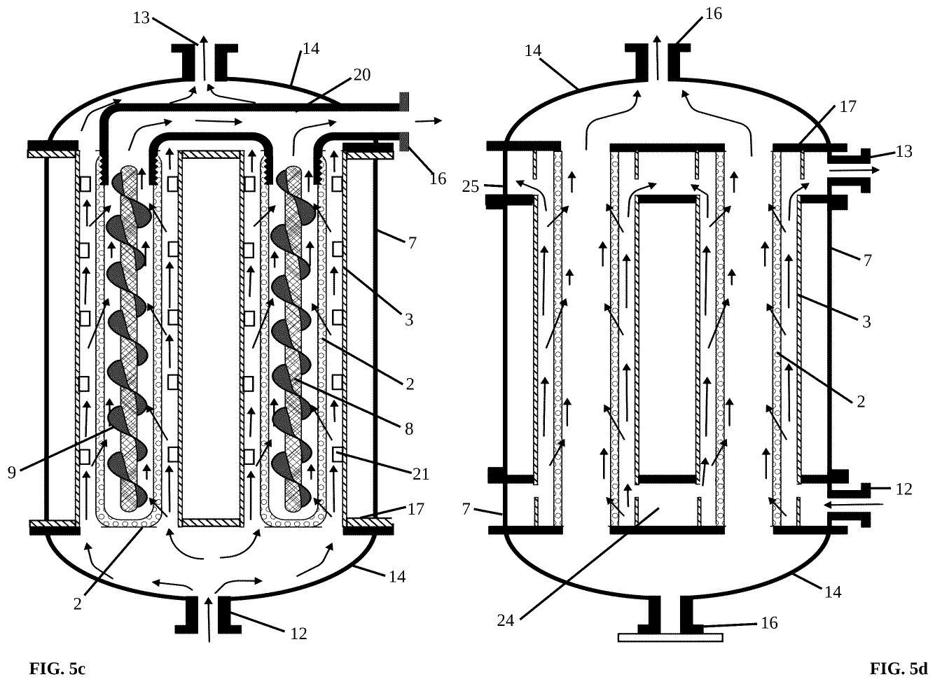

In one aspect, this invention introduces a TFF filter design that utilizes the larger outer surface of an outer tube as the primary filtration working surface, as depicted in FIG. 5a. This design incorporates a filter housing 3, closely enveloping a membrane tube 2 to create narrow spaces that serve as feed flow channels for the feed 12. These flow channels may integrate various internal structures aimed at reducing flow recirculation rates, mitigating membrane fouling, and impacting turbulence levels effectively. In one embodiment, a spiral flow guide is implemented within the gap, enabling the feed stream to rotate around the membrane tube while flowing axially. The flow guide may be continuous or discontinuous. Another design variation can employ varying geometries, such as baffles, within the feed flow channel to regulate turbulence levels and achieve the desired differential pressure and turbulence profile, ultimately reducing membrane fouling. The flow guide features can be located on either the tube housing 3 or the membrane tube body. The FIG. 9 exemplifies an embodiment where the membrane tube 2 features structures 21 on its exterior to regulate feed flow and increase the filtration surface area. In some instances, the outlet flow connects to a distributor tube 20 responsible for collecting permeate and directing it out of the filter.

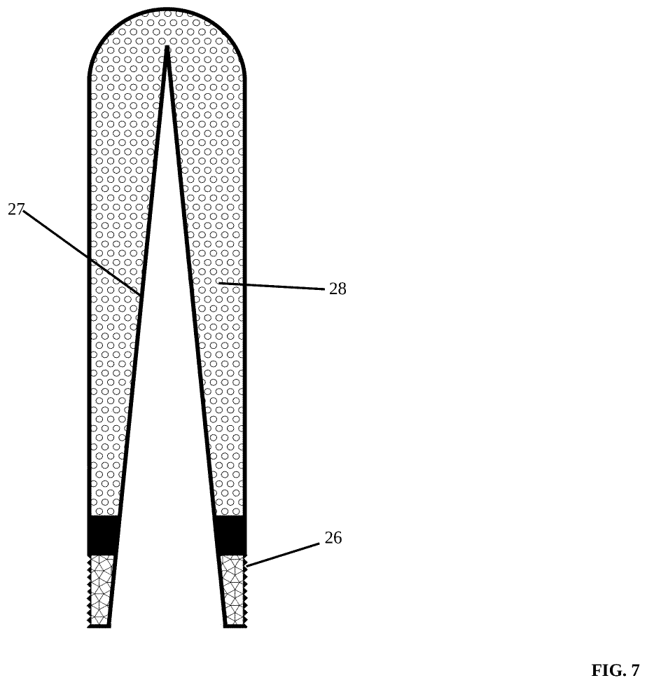

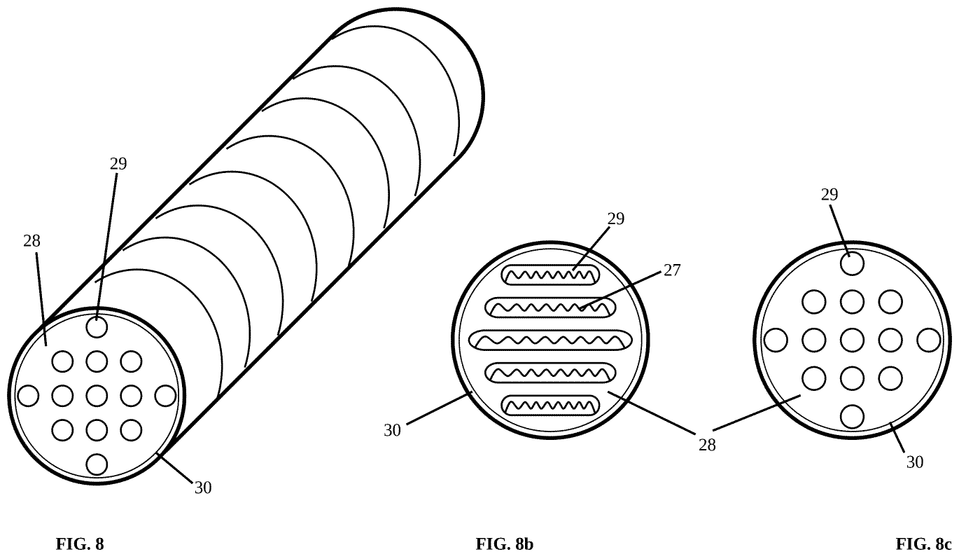

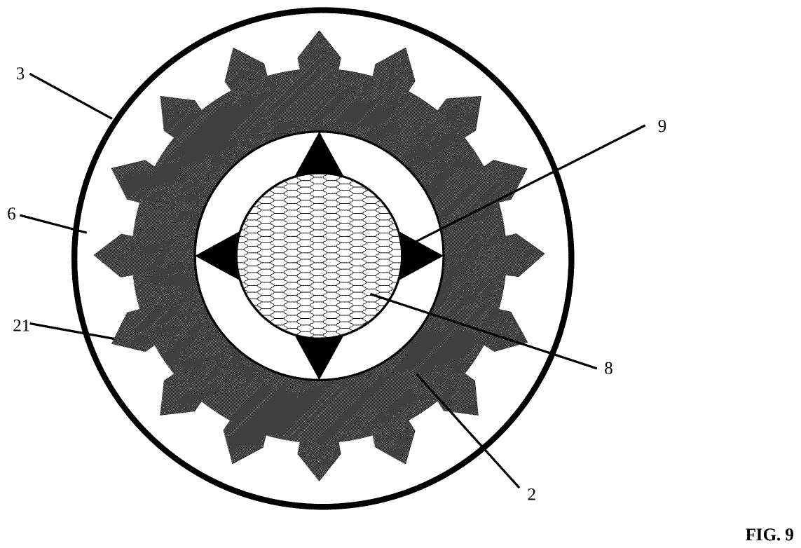

In certain embodiments, a core (depicted in FIG. 7), similar to the one disclosed in FIG. 3, is inserted into the lumen of the membrane tube to control the flow resistance of permeate and generate a more consistent TMP profile.

### Multiple Tube Filter Design Outside-In.

Additionally, this invention introduces alternative TFF tubular filter designs in which multiple membrane tubes with tube housing 3 are incorporated into a TTF device, akin to a hollow fiber filter. In certain embodiments, as demonstrated in FIG. 5b, all ports, including permeate ports 16, feed port 12, and retentate port 13, are situated at the filter end caps 14. The tubes with tube housing are potted inside the filter housing 7. In other embodiments, both ends of a membrane tube are connected to flow distributor pieces as shown in FIG. 5b. This approach allows for the sequential connection of multiple filters, where the outlet feed of one TFF device links to the feed inlet of another TFF device, and the outlet permeate can be directly collected or connected to the permeate ports of the next filter.

In some alternative embodiments, only one end of the membrane tube may be connected to a flow distributor piece 20 for the permeate to be collected, while the other end is sealed, as illustrated in FIG. 5c. This configuration requires only one permeate port 16, simplifying the design of one of the end caps 14.

In other variations, only the permeate ports 16 is connected to the end cap 14 of the filter, and the permeate collected through the lumen, while the feed port 12 and retentate port 13 are connected to the side of the filter housing 7. The feed flows within the gap formed by the membrane tube and its tube housing, as demonstrated in FIG. 5d. In certain implementations, the tube housing is fixed inside a filter housing 7, and the feed chamber 24 is contained within a feed chamber housing 25, as shown in FIG. 5d, to distribute and collect the feed flow. Permeate ports 16 are located on the end caps, as illustrated in 5d. For some embodiments, one end of the membrane tubing can be sealed.

In certain embodiments, the membrane tube and tube housing can form a filter element and then be secured in a filter, where the permeate inside the lumen can be collected through a duct that penetrates the membrane housing and is pooled inside the filter housing. The filter can have one or more permeate ports on the side of the filter, as shown in FIG. 5e. This design allows the filters to be easily retrofitted to existing filtration systems.

For each design shown in FIG. 5a through Figure Se, the feed flows through the gap formed by the tube housing and the outer surface of the membrane tube. In some implementations, the inner wall of the tube housing can have structures that regulate the flow trajectory, flow pattern, turbulence, and flow resistance of the feed flow. In other implementations, the flow can rotate around the tube while passing through the gap to increase the flow trajectory length and reduce the flow rate.

In some embodiments, the lumen can have a core to control the flow pattern, pressure drops of permeate flow, and reduce the actual TMP variance through the membrane tube. In these embodiments, a core is inserted in the tubular membrane (as shown in FIG. 3) to mediate permeate pressure. The core has a structure or pattern to allow permeate flow but create flow resistance to mediate permeate pressure.

In various embodiments of this invention, a central core or duct 27 can be incorporated within the core structure, allowing permeate to flow out, as depicted in FIG. 7. This core, if constructed with semipermeable materials, can also function as a secondary filtration element. Further, the core may have threads to allow it to be threaded into the tubular membrane, which would have threading to receive the core.

The invention has presented a selection of possible port connection methods, but it should be noted that numerous other combinations of connections are encompassed by this invention. Minor alterations in the connections or straightforward variations in the geometry, shape, or methods for securing the inserts inside the membrane tube are, as such, anticipated by this disclosed invention.

### Flat Tube Design Outside in.

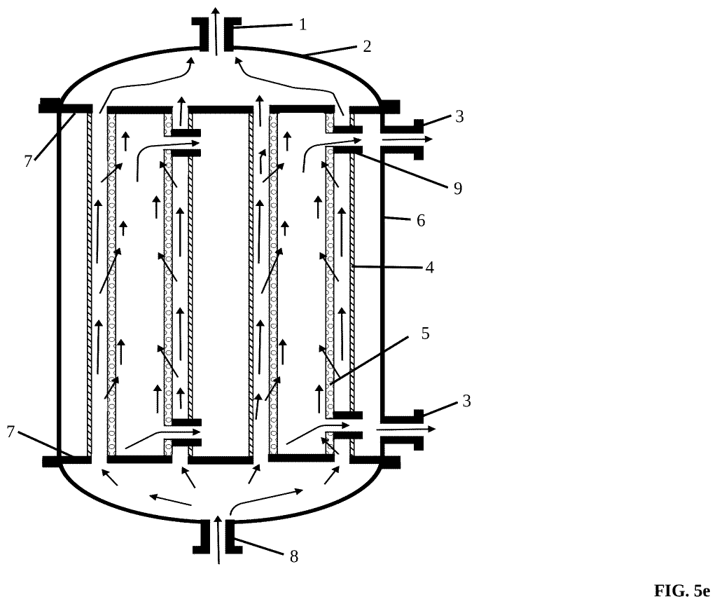

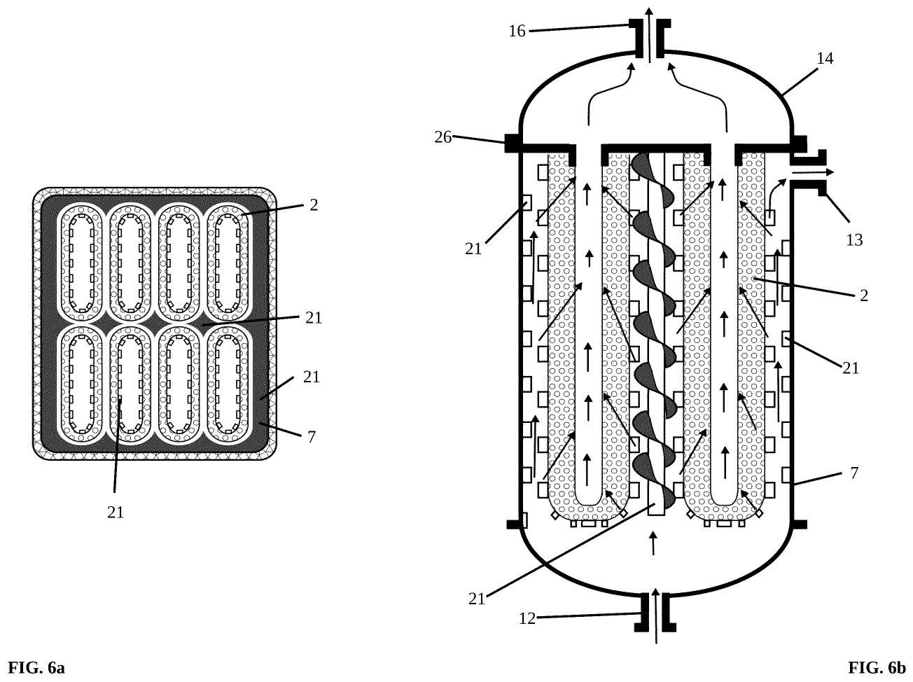

By utilizing the external surface as the primary filtration medium, each tube can provide more surface area than a circular membrane tube with the same cross-sectional area. This invention also introduces methods involving flattened membrane tubes instead of circular ones, as illustrated in FIGS. 6a and 6b. These membrane tubes (2) can assume various shapes and arrangements suitable for filters designed to use the external surface as the filtration working area, combined with tube housing featuring permeate ports on the side of the filter. The tube design and arrangement techniques, effectively utilizing the internal space of filters to accommodate larger filtration surface areas as demonstrated in FIG. 4c, are equally applicable to designs where the outer surface serves as the membrane filtration working area. In such designs, a tube housing is not required, but the outer surface of the tube can be engineered with structures (21) and flow channels to enhance turbulence.

Membrane tubes can be securely mounted on a base, which may be composed of stainless steel or other materials, using various methods. One approach involves fixing the membrane tube into a matching slot on the plate, utilizing a sealing element such as O-rings between the slot and the membrane tube. Alternatively, a mounting base featuring hose barb connections that insert into the membrane tubes can be employed. This invention offers multiple ways, including epoxy or polyurethane potting, to mount and secure filter tubes on the plate, and minor variations in the connection of the membrane tubes are covered by the invention.

Each of the filter designs previously disclosed in FIG. 5a through FIG. 5f can be extended to accommodate non-circular membrane tube designs. The geometry of the filter housing may also be non-circular, such as rectangular, to facilitate the packing of membrane tubes in the housing.

The membrane tubes can be used without tube housing, and the placement of feed or permeate ports can be adjusted to the end cap or the side of the filter housing. Different structural designs for filters are possible, and straightforward variations in port locations and flow distribution are considered within the scope of this invention.

In certain embodiments, the housing may feature integral structures, such as those depicted in FIG. 6b as structure 21, designed to manage feed flow patterns, flow resistance, and feed pressure along the membrane tube. These structures can take the form of baffles, flow guides, ring or spiral shapes, or other configurations. They serve to reduce the recirculation rate needed to generate sufficient shear rate to minimize membrane fouling.

In other embodiments, cores or inserts with structured patterns can be inserted into the lumen to mediate point permeate pressure. These structures may involve baffles, flow guides, meshes, or other shapes, with the invention accommodating a range of possible dimensions.

Additional designs are also applicable to filters employing tubular membranes of other shapes, such as rectangular. These designs help minimize the gap between membrane tubes, similar to the configuration illustrated in FIG. 4c.

Furthermore, this invention discloses structural features for membrane tubes designed to increase filtration surface area and regulate feed flows. These design features involve employing non-flat surfaces to maximize membrane contact with the feed flow, effectively increasing the surface area. As illustrated in FIG. 9, a specific design showcases a straight ridge, but the invention encompasses various other designs beyond this example. In certain embodiments, the ridge surface may feature secondary structures affecting flow resistance and flow turbulence levels, while in other instances, the extruded ridge may assume a spiral shape to lengthen the flow trajectory and reduce recirculation rate requirements. These design variations and modifications, both those specifically detailed and those within the broader scope of the invention, provide a comprehensive solution for optimizing tangential flow filtration systems and enhancing their performance across a wide range of applications.

This invention introduces various methods for regulating permeate pressures in tubular membrane filters, one of which involves wrapping the membrane tube with fine fibers or other materials to create layers of porous materials 30. These porous layers serve to create additional flow resistance, and their thickness and material composition can vary along the membrane tube from the feed inlet to the feed outlet. The layers can also be a composite of the same or different materials. At some portions of the membrane tube, these layers may not be semipermeable, allowing unrestricted permeate flow. For ceramic TFF filters with multiple tubes or hollow channels 29 incorporated in a single cylinder, these wrapping materials can be applied outside the cylinder. In some cases, inserts in porous material 28 may form the flow channels. These wrapping material can also be another layer of membrane working as secondary filtration medium.

### Tube Module and Multiple Chamber Design:

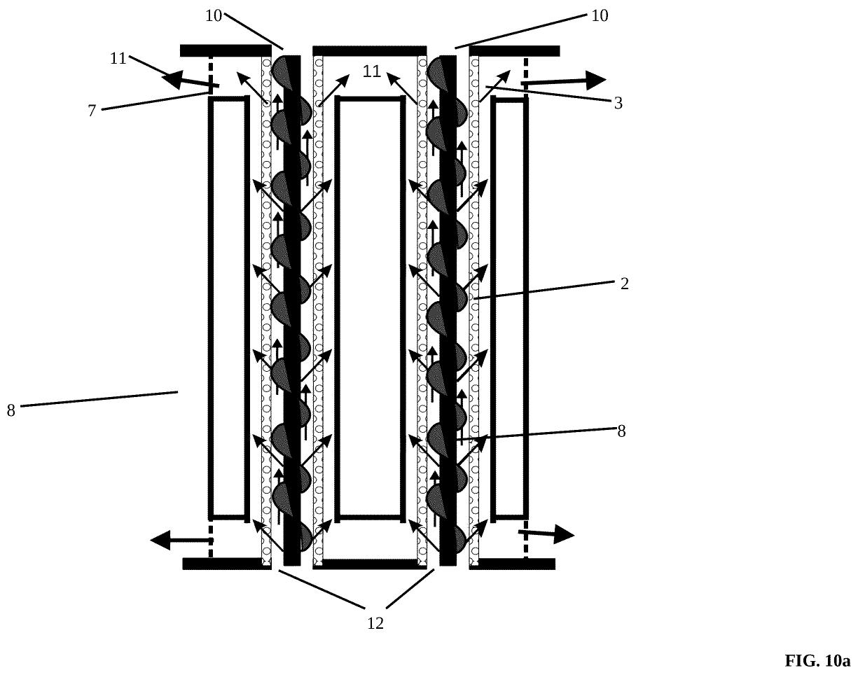

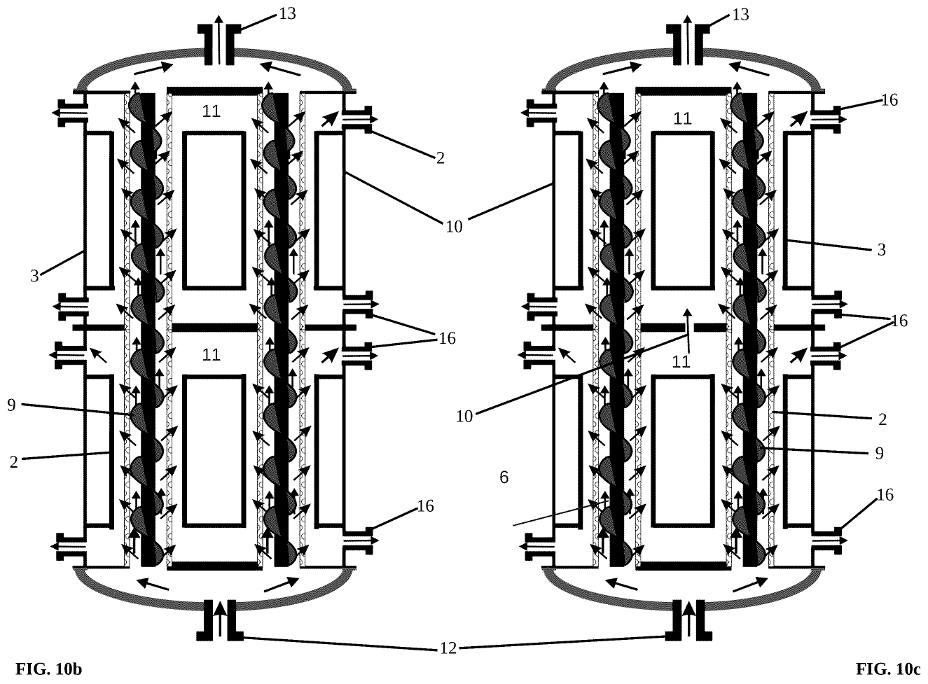

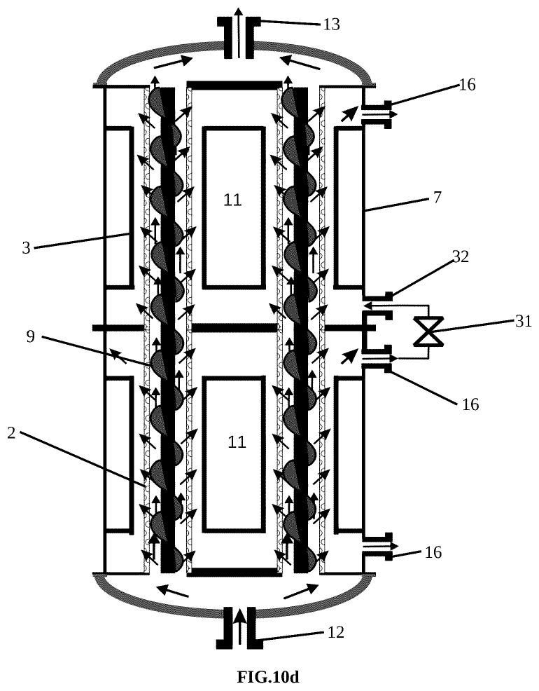

In situations where membrane tubes are operated under low permeate flux conditions, the permeate flow rate may be insufficient to generate the necessary flow resistance to match the pressure drop (delta P) of the sample feed flow in a TFF operation. Regulating flow resistance in the permeate can be challenging when trying to engineer the permeate flow channel. This invention presents a filter design illustrated in FIGS. 10a through 10d. The invention provides several designs that enable the modular construction of membrane tube modules, as depicted in FIG. 10a. Each filter module consists of tubular membranes and may include one or more membrane tubes. Multiple modules can be installed in a filter housing 7, ideally separated by gaskets, to form multiple chambers on the permeate side. Each chamber can feature one or more permeate ports. Additionally, each of the membrane tube can have single channels or multiple channels.

Each permeate chamber can be equipped with valves 31 or other flow control devices, as shown in FIGS. 10b and 10d, to regulate the permeate pressure in that chamber. By controlling the permeate pressure for each chamber, a more uniform overall TMP profile can be maintained throughout the entire filter by properly restricting permeate flow. This invention also introduces mechanisms to create flow channels for permeate to move from one chamber to another, as depicted in FIGS. 10c and 10d. The dimensions of the flow channels connecting different chambers can be varied to generate the necessary flow resistance for controlling the TMP in each chamber.

Permeate from one chamber 11 can be connected to the following chamber through one or more channels 6. In some designs, the channels may be thin gaps or openings in the gasket that separates two sections of membrane tubes. In other designs, the channels may be holes, pipes of proper dimensions, or other devices positioned between membrane tubes that penetrate the gasket, as shown in FIG. 10c. The flow resistance caused by these channels is engineered to match the pressure drop of the feed flow, ensuring a constant TMP. Various structures can be used to separate permeate flow into multiple chambers, with one design option being a gasket. Each chamber can have one or more permeate ports that can further connect to sections of permeate tubing. These tubing sections can be equipped with valves or other flow control devices to regulate the permeate pressure in the chamber. By controlling the permeate pressure for each section, a more uniform overall TMP profile can be maintained throughout the entire filter.

While FIGS. 10a-10d illustrate filter designs with tube housing and tube inserts, the multiple chamber designs are applicable to membrane tubes without tube housing or tube inserts. More filter elements and more chambers can be connected sequentially to create longer filter designs. Each chamber can share a filter housing, or can have independent but connected housing. In some embodiments, each chamber can have a permeate port, which can also connect to a permeate pump for permeate control and a pressure sensor for permeate monitoring. If a permeate pump is not used, a permeate valve and/or permeate flow meter can be used to control the permeate rate. Each of module can use external surface or internal surface as working surface.

The filtration modules used in filters with sequentially installed modules to control permeate pressure can also employ hollow fiber as the filtration medium. Hollow fibers are potted into modules, and each module has a module housing with openings at the side of the module housing for permeate to exit the module when the sample flows through the lumen of the hollow fibers. The filter designs previously disclosed for membrane tubes are also applicable to hollow fiber elements.

In certain embodiments of the multiple chamber filter designs illustrated in FIGS. 10b through 10d, the elements used in filters are filter elements with multiple tubes, such as ceramic filter elements with multiple tubes, and each tube can have multiple channels.

For all these disclosed membrane tube designs, the membrane tube can take different shapes, with the cross-section being oval, star-shaped, polygonal, or other configurations. The membrane tube can also be made from two or more different materials. Additionally, the membrane tube can be constructed using knitted mesh, such as fine metal meshes, rather than a traditional membrane and sintered tube.

### Application Cases of Using External Surface as Working Surface:

In contrast to the largest existing TFDF filter design (40 tubes, each with a filtration surface area of about 150 cm², totaling 0.6 m² of filtration surface area, known as the “X06” series with a 6″ diameter filter housing), this invention presents a design that utilizes flattened membrane tubes, allowing for significantly more filter surface area to be accommodated within the same 6″ ID housing. In this design, rectangular membrane tubes with a 2 mm slit between the inner surfaces, 3 mm wall thickness, and 2 cm width, each tube with an effective length of 100 cm, can provide approximately 400 cm² of surface area. These membrane tubes are positioned closely together, with tube-to-tube or tube-to-housing distances falling within the range of 1-3 mm. In one specific design, 75 tubes are sealed inside a 6″ ID tubing, resulting in a total surface area of about 3.0 m², in contrast to the Repligen X06 series 6″ TFDF filter with a filtration surface area of 0.6 m² at the same length. Inside the filter housing, structures are installed to fill the interstitial space, controlling the distance between the membrane tube and the wall, managing the flow trajectory, as well as supporting the membrane tube. Structures are also introduced between the membrane tubes to regulate the flow pattern and reduce the recirculation rate necessary to generate sufficient shear and prevent membrane fouling.

In one specific implementation, the recirculation flow is supported by a Levitronix pump, such as the PuraLev 2000SU. Different design variations involve the inclusion of a mesh-like material between the membrane tubes to manage the flow pattern and flow resistance of the feed flow. In other designs, a flat sheet insert/core is included inside the membrane tube (within the tubing slit) to mediate the flow resistance of permeate flow. The dimensions and structure of the insert are engineered so that the flow resistance is high near the feed inlet and low near the feed outlet. In one design, the thickness of the tube insert/core decreases from the feed inlet toward the feed outlet, ensuring consistent transmembrane pressure throughout the membrane tube. Other designs incorporate inserts with baffles to create additional flow resistance for the permeate.

### Materials and Variations:

There are no limitations on the materials for the macroporous membrane, housing, core, filter housing, or flow distributor. The membrane tube materials can be polymers (such as PTFE, PE, etc.), metals, or ceramics. The membrane tube can also be coated with other materials, such as PVDF or other surface modifications. Composite membranes using multiple materials are also possible. The actual working filtration surface can consist of mesh materials, either in polymer or metal, or other materials. The mesh materials can include a base supportive structure and may vary. Simple variations in materials do not constitute a part of the invention. The core/insert can also be made of metal, polymers, or other materials. The tube housing can be composed of metal, polymer, or other materials, including material composites.

### Utilizing Porous Flat Sheets:

It is also possible to use porous flat sheet plates as the filtration medium and assemble the flat sheet plates in a TFF device, much like the flat sheet cassette format. The edges of porous flat sheet plates can be sealed using epoxy, polyurethane, or blocked with non-porous materials to completely prevent liquid flow. Baffles, flow guides, mesh, or other structures can be applied in the space between the plates. It is essential that the differential pressure for feed flow and permeate flow remains consistent, with the flow channels for permeate flow being narrower than those for the feed flow. Or a multiple chamber design of to control the TMP.

It is envisioned that the aspects of this invention represent a novel system configuration, marked improvement over conventional tangential flow filter design methods. While this system may appear as an assembly of pumps, filters, tubing, and sensors, its core innovation lies in the multi-stage architecture itself, facilitating continuous high-capacity processing. This unique system topology unlocks significant advantages in terms of throughput, efficiency, and flexibility that are not currently attainable with conventional batch and single-pass tangential flow filtration systems.

Moreover, while a preferred embodiment has been described for illustrative purposes, those skilled in the art will recognize the possibility of variations, additions, and substitutions that can be made without deviating from the essence and scope of the invention, as defined by the accompanying claims. These foreseeable modifications are hereby anticipated.

Accordingly, the applicant intends to incorporate such modifications, combinations, and integrations that fall within the purview and objectives of the disclosed invention. The use of singular terms should be understood to encompass plurals unless explicitly stated or evident from the context. Conjunctions connect any disjunctive and conjunctive clause combinations. Terms like “and/or” should, therefore, be broadly interpreted to mean “and,” “or,” or “and/or,” except where context imposes specific limitations.

### INDUSTRIAL APPLICATION

The invention finds application in various fields, primarily in biotechnology and biopharmaceutical manufacturing, where efficient separation and purification processes are essential. Specifically, this invention is poised to revolutionize the tangential flow filtration (TFF) industry, impacting areas such as cell separation, perfusion, pharmaceuticals, biotechnology, food and beverage, and environmental processing.

In the pharmaceutical and biotechnology sectors, the invention's TFF filtration elements provide an efficient means of separating valuable bioproducts such as therapeutic proteins, monoclonal antibodies, and vaccines from complex bioprocess streams. With enhanced control over point transmembrane pressure (TMP) and permeate pressure, these devices enable improved product yields, reduced processing time, and superior product quality. The ability to tightly regulate TMP profiles results in better separation efficiency and increased product purity, reducing cost, and enhancing the overall productivity of biomanufacturing processes.

Moreover, the invention's applicability extends to the food and beverage industry, where it can be employed for the clarification, concentration, and purification of various liquid products. Whether it's fruit juices, cultivated meat cells, dairy products, or edible oils, the innovative filtration elements optimize the efficiency of the separation process, ensuring superior product quality and minimizing waste.

Environmental applications encompass the treatment of wastewater, where the invention's capabilities in controlling TMP and regulating permeate pressure can be harnessed for the removal of pollutants, microorganisms, and suspended solids. This leads to more effective wastewater treatment processes and cleaner effluent, contributing to environmental sustainability.

What is claimed is:

1. A tangential flow filtration element comprising:
a. a single or multiple channel membrane tube for separating particles from a solution with feed flowing inside the lumen and filtrate penetrating the membrane wall;
b. a tube housing surrounding the membrane tube forming a narrow flow channel between the membrane tube and housing to regulate permeate pressure along the membrane tube; and
c. the flow channel having at least one open end for permeate exit.

2. The tangential flow filtration element of claim 1, wherein the housing segregates the flow channel into one or multiple chambers in the axial direction of the membrane tube, each chamber having ports on the housing for permeate exit.

3. The tangential flow filtration element of claim 2, wherein the ports connect to tubing sections and flow control devices including valves to provide additional permeate flow resistance control.

4. The tangential flow filtration element of claim 1, further comprising secondary material layers applied to all or part of the membrane tube to regulate permeate pressure and/or serve as a secondary filtration medium, wherein the layers differ in permeability, flow resistance, pore size, thickness and material.

5. The tangential flow filtration element of claim 1, wherein the flow channel has varying dimensions and structures to affect transmembrane pressure for desired profile along the membrane tube.

6. The tangential flow filtration element of claim 1, further comprising a core or insert secured inside the membrane tube lumen to reduce cross-section, regulate flow resistance and mediate turbulence.

7. The tangential flow filtration element of claim 1, wherein the internal surface of the membrane tube has structures affecting flow resistance, turbulence and trajectory.

8. The tangential flow filtration element of claim 1, wherein the membrane tubes have non-circular cross-sections.

9. The tangential flow filtration element of claim 1, wherein the membranes comprise porous ceramic, polymer, metal or mesh materials, or a composite of these materials.

10. The tangential flow filtration element of claim 1, wherein the membrane tubes are 0.2-1.5 mm ID and 0.45-2.5 mm OD hollow fibers of PES, PS, PVDF, PTFE or other materials potted with epoxy, polyurethane or other polymer resin.

11. The tangential flow filtration element of claim 1, further comprising a tangential flow filtration module enjoining two or more tubular membrane filtration elements assembled in parallel in a module housing with openings for permeate flow out.

12. The tangential flow filtration module of claim 11, wherein the membrane tubes have tube housings or wrapping layers for permeate pressure control.

13. The tangential flow filtration module of claim 11, wherein the membrane tubes have inserts and/or internal structures for feed flow control.

14. The tangential flow filtration module of claim 11, wherein a flow filtration device is constituted of a filter housing and two or more modules in sequence with filtrate flowing inside the lumen and penetrating the membrane wall and gaskets separating the modules into permeate chambers each with its own permeate ports.

15. The tangential flow filtration device of claim 14 further comprising channels connecting the permeate chambers of different modules with desired flow resistance.

16. The tangential flow filtration device of claim 14 wherein the gaskets have gaps, slots, holes or ducts restricting permeate flow between chambers.

17. A tangential flow filtration device comprising:
a. tubular membranes wherein feed flows outside the membrane and filtrate penetrates to the lumen; and
b. a filter housing or tube housing closely surrounding the membrane tubes forming a thin feed flow channel.

18. The tangential flow filtration device of claim 17, wherein the housing has structures or patterns to control flow trajectory, pattern and turbulence in the feed flow channel.

19. The tangential flow filtration device of claim 17, wherein the membrane tubes have non-circular cross-sections and inserts between the tubes and housing inner surface.

20. The tangential flow filtration device of claim 17, wherein one end of the membrane tubes is closed and the other connects to permeate ports.

21. The tangential flow filtration device of claim 17 further comprising an insert or core inside the membrane tube lumen to control permeate flow pattern and resistance.

22. The tangential flow filtration device of claim 21 wherein the membrane tube inner surface has structures to regulate permeate flow resistance and control TMP.

23. A tangential flow filtration device comprising:
a. one or more filter housings and two or more tubular membrane filtration modules in sequence with filtrate flowing inside the lumen and penetrating the membrane wall;
b. gaskets separating the modules into permeate chambers each with its own permeate ports.

24. The tangential flow filtration device of claim 23, wherein the membrane tubes have tube housings or wrapping layers for permeate pressure control and/or reduce the permeate hold up volume inside housing.

25. The tangential flow filtration device of claim 23, wherein the membrane tubes have inserts and/or internal structures for feed flow control.

26. The tangential flow filtration device of claim 23 further comprising channels connecting the permeate chambers of different modules with desired flow resistance.

27. The tangential flow filtration device of claim 23 wherein the gaskets have gaps, slots, holes or ducts restricting permeate flow between chambers.

28. The tangential flow filtration device of claim 23, wherein the membranes comprise porous ceramic, polymer, metal or mesh materials, or a composite of these materials.

29. The tangential flow filtration device of claim 23, wherein the membrane tubes across chambers are continuous and penetrate the gaskets.
